(19) United States
(12) Patent Application Publication
(10) Pub. No.: US 2015/0014180 A1
(43) Pub. Date: Jan. 15, 2015

(54) ELECTROCHEMICAL SYNTHESIS OF NITRO-CHITOSAN

(71) Applicant: The Research Foundation for the State University of New York, Albany, NY (US)

(72) Inventors: Gary P. Halada, Baiting Hollow, NY (US); Prashant Kumar Jha, Palatine, IL (US)

(21) Appl. No.: 14/374,982

(22) PCT Filed: Feb. 1, 2013
(86) PCT No.: PCT/US2013/024305

§ 371 Date: Jul. 28, 2014

Related U.S. Application Data
(60) Provisional application No. 61/594,563, filed on Feb. 3, 2012.

(51) Int. Cl. C08B 37/00; C02F 1/28; B09C 1/08; C25B 3/00

(52) U.S. Cl. CPC C08B 37/0006; C25B 3/00; C02F 1/286; B09C 1/08; C02F 2101/22
USPC 205/340; 205/426; 210/688; 405/128.75

(57) ABSTRACT

The present disclosure provides methods for producing chitosan derivatives and the derivatives formed by these methods. The processes of the present disclosure utilize electrochemical methods to functionalize and/or modify amine and/or hydroxyl groups present on chitosan, to form new derivatives. In embodiments, a nitro-chitosan derivative may be prepared. The altered cationic affinity of these derivatives make them excellent candidates for environmental applications, including water and waste treatments, and fertilizers.

### CROSS-REFERENCE TO RELATED APPLICATIONS

This application claims the benefit of, and priority to, U.S. Provisional Patent Application Ser. No. 61/594,563 filed on Feb. 3, 2012, the disclosure of which is hereby incorporated by reference in its entirety.

### BACKGROUND

The present disclosure provides processes for modifying chitosan and the resulting modified chitosan. Methods for using the resulting modified chitosan, in embodiments for removing contaminants including heavy metals such as chromium from the environment, are also provided.

Heavy metal contamination of soil and groundwater is a major environmental threat. Contamination from toxic heavy metals is present in as many as 63% of the 1200 sites on the National Priority List of the U.S. Environmental Protection Agency (EPA) for treatment of contaminated groundwater. For example, the heavy metal chromium is used in industrial processes such as metal plating, leather tanning and pigment production resulting in its release to groundwater. In aerated aqueous solutions, chromium is stable only as Cr(III) and Cr(VI). While Cr(III) is essential in small amounts in living beings for its role in carbohydrate metabolism, it is toxic at higher concentrations. Also, in alkaline environments, Cr(III) can oxidize to Cr(VI), which is toxic even at low concentrations, as it induces coetaneous allergies and becomes carcinogenic over long exposures.

Various methods developed for the removal of heavy metals from groundwater include: isolation and containment, mechanical separation, pyrometallurgical separation, chemical treatment, permeable treatment walls, electrokinetics, biochemical processes, phytoremediation, and soil flushing. Chemical remediation using naturally occurring biodegradable biomass has generated a great deal of interest due to its low cost and high efficiency. Some of the sorbents based on biomass that may be used include bark, seaweed, leaf mould and chitosan.

Chitosan is a linear, high molecular weight, crystalline polysaccharide of β-(1→4) linked N-acetyl-D-glucosamine. It is produced by the alkaline N-deacetylation of chitin, the second most abundant natural polymer after cellulose.

Changing the acetamide group of chitin to amine in chitosan increases the reactivity of chitosan, making it a better chelation and adsorption agent than chitin. The adsorption capacity of chitosan has been further enhanced using physical modifications, including conditioning as gel beads and the formation of microcrystalline chitosan.

Chitosan is a biocompatible, biodegradable, and renewable material. Chitosan is also a film-forming, hydrating, antibacterial material with wound healing properties. Chitosan has applications in the biomedical, agricultural, water treatment, waste treatment, food and beverage, cosmetics and toiletries, and biopharmaceutical fields.

Improved materials for use in the above applications, as well as methods for producing such materials, remain desirable.

### SUMMARY

The present disclosure provides methods for synthesizing novel chitosan derivatives. In embodiments the chitosan derivatives may be nitro-chitosan derivatives.

In embodiments, a method of the present disclosure includes contacting chitosan with a solvent to form a chitosan solution; adding to the chitosan solution an acid selected from the group consisting of hydrochloric acid, hypochlorous acid, organic acids, and combinations thereof, to reduce the pH of the chitosan solution to a pH from about 1 to about 7; applying a negative potential of from about −1 volt to about −5 volts to the chitosan solution by the introduction of a cathode and anode into the chitosan solution; forming a hydrogel comprising a nitro-chitosan derivative on the cathode; and recovering the nitro-chitosan derivative from the cathode.

In other embodiments, a method of the present disclosure includes contacting chitosan with a solvent to form a chitosan solution; adding to the chitosan solution an acid selected from the group consisting of hydrochloric acid hypochlorous acid, acetic acid, and combinations thereof, to reduce the pH of the chitosan solution to a pH from about 1 to about 7; applying a negative potential of from about −1.25 volts to about −3 volts to the chitosan solution by the introduction of a cathode and anode into the chitosan solution; forming a hydrogel comprising a nitro-chitosan derivative on the cathode; exposing the hydrogel on the cathode to a source of radiation selected from the group consisting of ultraviolet, X-Ray, gamma radiation, and combinations thereof; and recovering the nitro-chitosan derivative from the cathode.

### BRIEF DESCRIPTION OF THE FIGURES

Various embodiments of the present disclosure will be described herein with reference to the following figures, wherein:

FIG. 1 is a schematic overview showing conversion of chitosan to nitro-chitosan derivatives of the present disclosure;

FIG. 2 is a Fourier Transform Infrared Spectroscopy (FTIR) spectra obtained on a nitro-chitosan derivative produced in accordance with the present disclosure;

FIG. 3 are Raman spectra of electrochemically modified nitro-chitosan derivative of the present disclosure (ECM-chitosan) and a dried chitosan solution of the present disclosure at pH 2;

FIG. 4 is an X-ray photoelectron spectroscopic (XPS) spectra of a nitro-chitosan derivative produced in accordance with the present disclosure;

FIG. 5 is a depiction of the estimated structure of an alternate nitro-chitosan of the present disclosure;

FIG. 6 are NMR spectra of chitosan (OC1) and nitro-chitosan (CC3);

FIG. 7 is a graph of the results of batch equilibrium adsorption tests of nitro-chitosan derivatives of the present disclosure for chromium (VI);

FIG. 8 is a graph depicting a Langmuir model, representative of monolayer adsorption occurring on an energetically uniform surface without interactive molecules, for a nitro-chitosan derivative of the present disclosure;

FIG. 9 is a graph depicting the effects of pH on adsorption of chromium (VI) by electrochemically modified nitro-chitosan derivatives in the pH range of 1 to 8; and

FIG. 10 is a graph comparing a pseudo second order reaction with the experimental data obtained for the adsorption of chromium (VI) by electrochemically modified nitro-chitosan derivatives of the present disclosure.

### DETAILED DESCRIPTION

Disclosed herein is an electrochemical method for the synthesis of novel chitosan derivatives, including nitro-chitosan derivatives. These new derivatives of chitosan alter various properties of chitosan, including its affinity towards cations, by changing the functional groups on the chitosan polymer. The process results in formation of nitro groups on chitosan. Nitro groups are formed through oxidization of a fraction of the amine groups of chitosan. The chitosan derivatives have a higher affinity for toxic metals, in embodiments chromium, a known contaminant in soil and water.

Chitosan possesses a primary amine, a primary hydroxyl and secondary hydroxyl groups. These reactive functional groups make chitosan amenable to further functionalization and modification.

In accordance with the present disclosure, an electrochemical process for modification of chitosan is utilized to prepare a nitro-chitosan biopolymer. The nitro-chitosan polymer is synthesized as an oxidized variation of chitosan, involving a radiative and electrochemical process to transform the amine groups to nitro and/or nitroso groups. As used herein, a “nitro-chitosan” derivative includes a modified chitosan derivative possessing nitro groups, nitroso groups, or any combination thereof.

To carry out the processes of the present disclosure, chitosan is dissolved in water or a suitable solvent such as alcohols. The volume of water or other suitable solvent used to form this solution may be from about 10 ml to about 1 liter, in embodiments from about 100 ml to about 200 ml. The amount of chitosan may vary, and can be present in amounts from about 1% to about 50% by weight of the solution, in embodiments from about 2% to about 5% by weight of the solution. In embodiments, the solution may be formed with heating from about 10° C. to about 90° C., in embodiments from about 20° C. to about 35° C. The solution may also be formed with mixing at a rate of from about 1 revolutions per minute (rpm) to about 1000 rpm, in embodiments from about 10 rpm to about 200 rpm. The solution may be formed over a period of time from about 1 minute to about 48 hours, in embodiments from about 5 minutes to about 5 hours. The resulting chitosan solution may have a pH from about 1 to about 8, in embodiments from about 2 to about 7.

Once formed, the pH of the solution may then be lowered by addition of an acid thereto. Suitable acids include, for example, hydrochloric acid (HCl), hypochlorous acid, or organic acids such as acetic acid, combinations thereof, and the like. The amount of acid added to the solution will depend on the amount of chitosan and solvent utilized to form the solution. The acid may have a molarity from about 1 to about 10, in embodiments from about 0.5 to about 2. In embodiments, the acid may be added to lower the pH of the chitosan solution so that the chitosan solution possesses a pH from about 1 to about 7, in embodiments from about 2 to about 6.

After the pH of the solution has been lowered as described above, to form a nitro-chitosan derivative of the present disclosure, a negative potential versus Open Circuit Potential (OCP) is applied to the solution, by the introduction of a cathode and anode into the solution. Cathodes may be made of any suitable material with the purview of one skilled in the art, including stainless steel, graphite, silver, gold, and/or platinum. The negative potential should be equal to or greater than 1 volt (V), in embodiments from about −1 volt to about −5 volts, in other embodiments from about −1.25 volts to about −3 volts.

On application of the negative potential, a localized zone of high pH is created near the cathode. The pH in this localized zone may be from about 6 to about 13, in embodiments from about 7 to about 12. The chitosan present in this localized zone of high pH absorbs electrons, is deprotonated and is deposited on the cathode, thereby forming a hydrogel on the cathode.

Formation of the hydrogel layer including chitosan on the cathode restricts the mobility of the water or other solvent molecules. Subsequent reduction of the hydrogen ions (H+) results in formation of hydrogen gas, which creates the region of high pH at the cathode.

Under these conditions, the reaction then changes from reduction of H+ to reduction of H₂0, which produces entrapped hydroxyl (OH⁻) ions within the hydrogel film including chitosan that is coating the cathode.

The hydrogel film possessing the entrapped OH⁻ ions is then exposed to a suitable source of radiation, in embodiments ultraviolet (UV) radiation, X-Ray, gamma radiation, combinations thereof, and the like, providing additional energy and promoting the reaction of the OH⁻ ions and the amino groups on the chitosan. UV radiation may be applied from any suitable source. In embodiments, the UV radiation is applied at a wavelength from about 50 nm to about 400 nm, in embodiments from about 75 nm to about 350 nm.

The reaction of the OH⁻ ions and the amino groups on the chitosan results in the formation of nitro-chitosan and/or nitroso-chitosan in the hydrogel film formed on the cathode. The monomer units are shown in FIG. 1, where (a) is chitosan and (b) and (c) are monomer structures of the nitro-chitosan and nitroso-chitosan derivatives, respectively.

In embodiments, the nitro-chitosan derivative includes a monomer of the following formula:

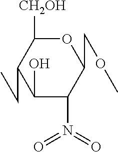

In other embodiments, the nitro-chitosan derivative includes a monomer of the following formula:

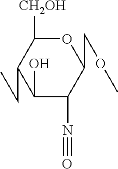

Once formed, the nitro-chitosan and/or nitroso-chitosan may be removed from the cathode using means within the purview of those skilled in the art. In embodiments, the hydrogel may be peeled off the electrode and mechanically crushed into a powder for subsequent use.

The electrochemical synthetic processes of the present disclosure are scalable and provide facile process control parameters. Limited use of toxic oxidizing and reducing agents in the processes of the present disclosure provides an environmentally friendly process.

Once formed, the resulting nitro-chitosan derivatives may be used as chelating agents for removing contaminants from soil and/or groundwater. The resulting nitro-chitosan derivatives are better chelating agents compared to pure chitosan for contaminants including chromate and other toxic metal ions such as uranyl, combinations thereof, and the like, and have higher metal binding capacities than chitosan. Thus, the nitro-chitosan derivatives of the present disclosure perform better than nitro-chitosan in environmental applications, including soil treatments, groundwater treatments, water filtration, and fertilizers, as well as drug delivery devices, cosmetics, pharmaceuticals, and the like.

The amount of chitosan derivative of the present disclosure to be added to soil and/or groundwater will vary depending on the extent of contamination. After contacting the soil or groundwater with the chitosan derivatives of the present disclosure, the complex formed by the chitosan derivatives and contaminant such as chromium may be removed by methods within the purview of those skilled in the art, including spraying for soil applications, and pump and treat for groundwater applications.

The altered cationic affinity of the chitosan derivatives of the present disclosure towards molecules and ions render these materials an excellent choice for applications including:

1) Water and waste treatment: the increased affinity of the nitro-chitosan and/or chloro-chitosan derivatives for the contaminants leads to higher mass of contaminant removed per unit mass of molecule;

2) Fertilizer: the altered chemical affinity, along with natural biodegradability, results in higher loading of fertilizer with controlled release; and

3) Pharmaceutical: biocompatibility of chitosan is exploited for controlled release of drugs due to altered release kinetics.

The following Examples are provided to illustrate, but not limit, the features of the present disclosure so that those skilled in the art may be better able to practice the features of the disclosure described herein.

### Example 1

Electrodeposition of chitosan. A chitosan solution was made by adding about 1.5 grams of a low molecular weight chitosan (obtained from Sigma Aldrich (75-85% deacetylated)) to about 120 ml deionized (DI) water under constant stirring at a rate of about 100 rpm. Hydrochloric acid (HCl), having a molarity (M) of about 1 M, was then added drop wise until all the chitosan was dissolved, which occurred as the solution reached a pH of about 2.

A polished type 304 stainless steel (metal composition approx. 19% Cr 9% Ni, with the balance Fe) was chosen as the working electrode. A platinum wire served as the counter electrode. A Gamry Reference 600 potentiostat was used to perform electrochemistry and Gamry Instrument Framework software was used for control and monitoring of voltage and current. Controlled potential coulometry at a voltage of about −3 V (versus Ag/AgCl reference electrode) was applied for about 5 minutes. The resulting hydrogel was rinsed in DI water to remove any chitosan solution entrapped in the resulting hydrogel formed on the cathode. The gel was then exposed to UV light (20 Watts at a distance of 6 cm) for about 10 minutes, after which it was peeled from the electrode and left to dry for about 48 hours. The dried gel film was then crushed mechanically to form a powder for spectroscopic analysis and absorption experiments.

### Example 2

Fourier Transform Infrared Spectroscopy (FTIR) spectra were obtained on the powdered polymer produced in Example 1 using a Nicolet 760 infrared spectrometer modified to collect data in both mid- and far infrared regions. Samples were ground to a fine powder. Spectra were collected using an MCT-A detector (commercially available from Thermo Orion) with data resolution set to 2 cm⁻¹ and summed over 256 scans to improve the signal-to-noise ratio. A Gemini sampling accessory (Spectra-Tech) collected diffuse reflectance data from powder samples. The analysis chamber was purged continuously with doubly dried air to prevent the absorption of water vapor, and a globar-type IR source was used.

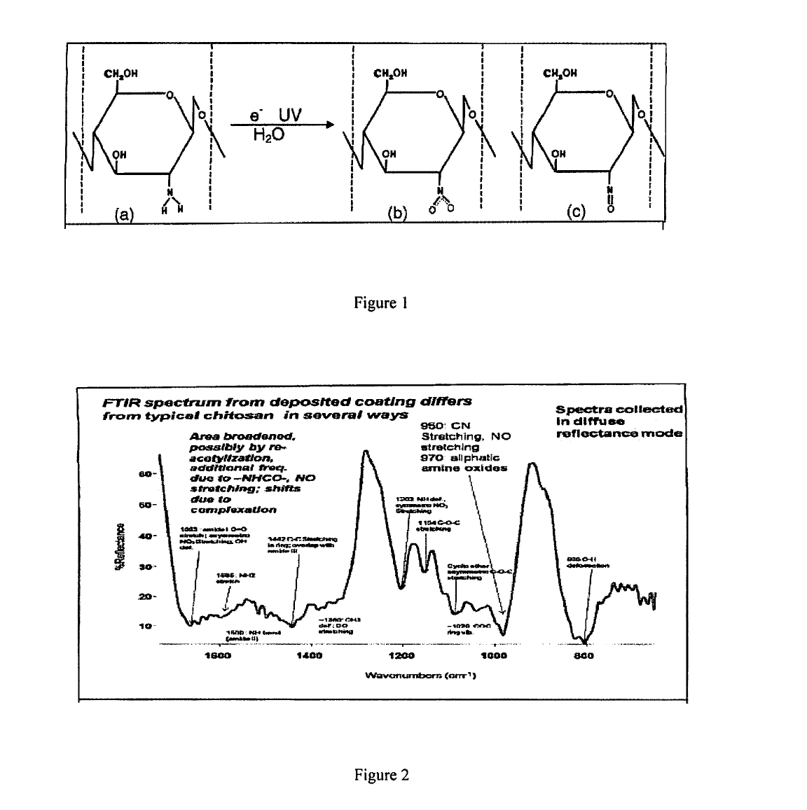

The resulting FTIR spectrum, shown in FIG. 2, illustrates peaks at 970 and 1663 cm⁻¹, indicating oxidation of the amine group in chitosan.

In addition to FIG. 2, the results of FTIR spectroscopy of the deposited material are summarized in Table 1. The peaks at 1663 cm⁻¹, 1203 cm⁻¹ and 970 cm⁻¹ indicate oxidation of some of the nitrogen in chitosan as a result of the electrochemical process.

TABLE 1
Peak positions and assignments for Fourier Transform Infrared
spectrum of electrochemically modified (ECM) chitosan.

| Peak (cm⁻¹) | Assignment |
|---|---|
| 1663 | combination of amide C═O stretching, asymmetric NO₂ |
| | stretching and OH deformation vibrations |
| 1585 | NH bending frequency |
| 1442 | C—C stretching vibration |
| 1380 | combination of CH₃ deformation and CO stretching |
| | frequencies |
| 1203 | combination of NH deformation and symmetric NO₂ |
| | stretching vibrations |
| 1154, 1020 | symmetric and asymmetric stretching vibrations of |
| | C—O—C respectively |
| 970 | amine oxide |
| 805 | O—H deformation |

### Example 3

Raman Spectroscopy was then performed on the powdered polymer produced in Example 1. A Nicolet Almega dispersive Raman spectrometer, with a 785 nm laser source, was used for analysis. (OMNIC for Nicolet Almega, software version 7.3, was used to process data.) Powdered samples were placed on quartz slides and Raman microspectroscopy in reflectance mode was used for data acquisition. Data were collected in the 3600-400 cm⁻¹ range. An average of 10 scans with 5 second accumulation time for each exposure was collected. For comparison, a chitosan solution at pH 3 was dried (without any applied potential) on stainless steel and similarly analyzed.

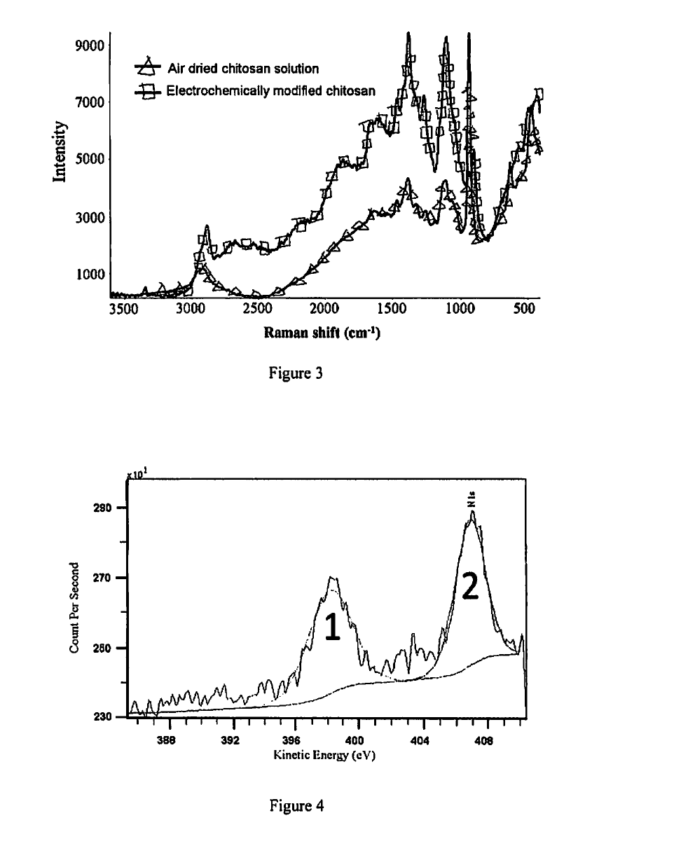

Raman spectra of the air-dried chitosan film, as well as electrochemically modified chitosan (ECM-chitosan), are shown in FIG. 3. The peak at 2920 cm⁻¹ from the air-dried sample most likely resulted from a combination of asymmetric C—H vibration from CH₂OH and C—O stretching vibration from hydroxyl group. The broad peak at 1634 cm⁻¹ was from a combination of amine N—H deformation and aromatic C═C stretching vibrations. The peak at 1465 cm⁻¹ was from the C—H scissor vibration while the peak at 1384 cm⁻¹ was from the CH₂ wagging. Peaks at 1325 cm⁻¹ and 1188 cm⁻¹ were attributed to C—N stretching from the amine group. The peak at 1256 cm⁻¹ was attributed to OH deformation vibration of the CH₂OH group. The peaks at 1188 cm⁻¹ and 820 cm⁻¹ were from symmetrical and asymmetrical C—O—C stretching in cyclic ether while the peaks at 935 cm⁻¹ and 468 cm⁻¹ were from C—O—C bonds between monomer units. The peaks at 628 cm⁻¹ and 560 cm⁻¹ were attributed to ring vibrations.

Raman spectrum of electrochemically deposited material showed various new peaks: a peak at 3345 cm⁻¹ from the N—H stretching vibration in C═N—H groups, while the peak at 1860 cm⁻¹ was from the C═O stretching vibration. The peak at 1589 cm⁻¹ was attributed to N—H bending in amine and the peak at 1525 cm⁻¹ was consistent with the asymmetric NO₂ stretching vibration. The peak at 901 cm⁻¹ was consistent with the C—N stretching vibration in nitro groups, and the new peak at 491 cm⁻¹ was from the NO₂ rocking vibration. Vibrational spectroscopy also indicated oxidation of a fraction of amine to imine and nitro groups, as well as oxidation of some of the hydroxyl groups to aromatic ketone.

### Example 4

To confirm oxidation and detect speciation of nitrogen, X-ray photoelectron spectroscopic (XPS) studies were carried out on the powdered polymer produced in Example 1. Sample preparation consisted of peeling the deposited film from the stainless steel substrate after immersion in liquid nitrogen for one minute. The film was removed using a stainless steel razor and mounted on the XPS sample holder using indium foil. XPS measurements were performed using a custom-designed spectrometer that utilized a VG Scientific (Fisons) CLAM2 hemispherical analyzer with lensing, controlled by a VGX900I data acquisition system. An Mg Kα_{1,2} (hν=1253.6 eV) X-ray source operating at 20 kV and 10 mA with a 20 eV pass energy was used at a pressure of 10⁻⁹ Torr.

Measurements were taken at a 90° take-off angle with respect to the surface and charge correction was done by referencing to the C 1s line of adventitious carbon (284.6 eV).

The resulting XPS spectrum of electrodeposited chitosan is shown in FIG. 4. Two peaks were present; with charge correction, they correspond to binding energies of 398.6 eV (NH₂) and a large, broad peak at 407 eV. The peak at 407 eV confirmed oxidation of nitrogen in chitosan, falling in the range of nitrate in cellulose nitrate (408.1 eV) and C—NO₂ nitro compounds (406.3 eV). In other words, in FIG. 4, Peak 1 corresponds to the primary amine (—NH₂), and Peak 2 corresponds to nitrate and/or nitronyl (N═O).

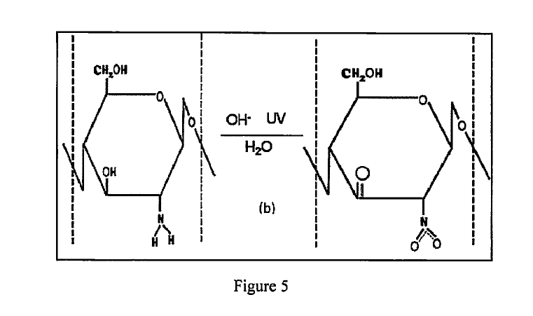

Hence, vibrational and X-Ray spectroscopy provided clear evidence of oxidation of at least a portion of the amine groups in chitosan to nitro groups and some hydroxyl groups to aromatic ketone. The estimated structure of this novel molecule is shown in FIG. 5. The oxidation was expected to have taken place by reaction of amine and hydroxyl group with OH⁻ ions formed by electrolysis of entrapped water molecules in the hydrogel structure as shown in the equations below.

—NH₂+OH⁻→═NH+H₂O+e⁻ equation (1)

═NH+5OH⁻→═NO₂+3H₂O+5e⁻ equation (2)

—OH+OH⁻→═O+H₂O+e⁻ equation (3)

Exposure of the hydrogel to ultraviolet light was found to increase the intensity of the oxidized nitrogen peak in X-ray photoelectron spectroscopic spectrum (not shown) indicating oxidation of a higher fraction of amine.

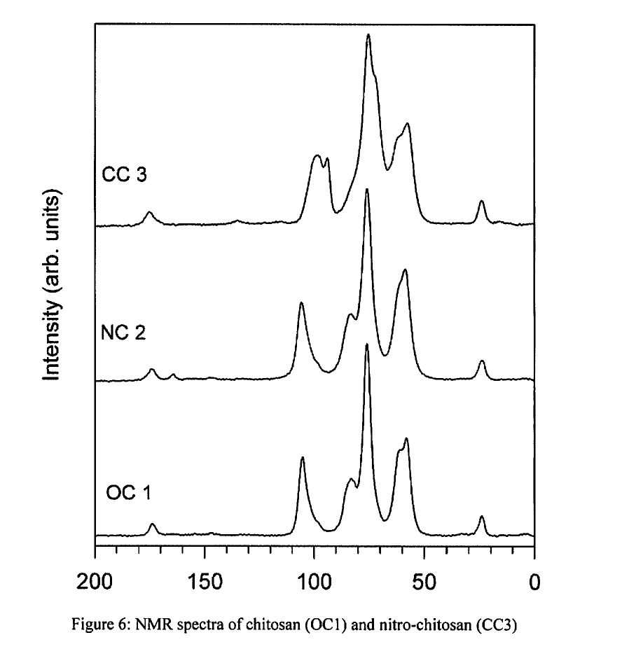

Nuclear Magnetic Resonance (NMR) was also conducted on the samples. FIG. 6 illustrates NMR spectra of chitosan (OCl) and nitro-chitosan (CC3), obtained using a solid state C13 CP/MAS NMR obtained at 100.6 MHz with a 400 MHz Varian Inova spectrometer.

### Example 5

Absorption experiments. A stock solution (about 1000 parts per million (ppm)) of Cr(VI) was prepared using K₂Cr₂O₇ from (Sigma Aldrich), in deionized water (>18MΩ/cm). The stock solution was then diluted to give standard solutions of appropriate concentrations. Batch adsorption experiments were conducted in 250 ml conical flasks and equilibrated using a magnetic stirrer. About 0.02 grams of the modified chitosan from Example 1 was added to 50 ml of the standard solution and equilibrated for about 30 minutes. The supernatant solution was then filtered and analyzed.

For equilibrium time determination, about 0.5 grams of modified chitosan from Example 1 was mixed in about 1 liter of 26 ppm Cr(VI) solution under constant stirring. About 2 ml of solution was removed at predetermined times, filtered, and analyzed.

To determine the effect of pH on adsorption, the pH of the 26 ppm Cr solution was controlled by introducing small amounts of 1M HCl and 1M NaOH solutions, while the remaining parameters were kept the same as that for the batch experiments. Chromium concentrations were measured using DCP-AES as set forth below.

Elemental analyses were carried out with an ARL Spectraspan VB Direct Current Argon Plasma Atomic Emission Spectrometer (DCP-AES). This system used a Czerny-Turner spectrometer with an Echelle grating and a 30° prism for order separation. At about 400 nm, reciprocal linear dispersion was about 0.122 nm/mm. For a 25 micron entrance slit, the spectral band pass was about 0.003 nm. Analyses were performed in single element mode, using standard settings and a solution flow rate of about 0.5 ml/minute. The emission line used for analysis was Cr 425.435 nm, observed at the 53^{rd} spectral order.

Under these analytical conditions, the 3-sigma detection limit was approximately 4 ng/g (ppb).

Standards used for calibration of the Cr analysis were prepared from SPEX CertiPrep Assurance® 1000 ppm plasma emission spectroscopy stock solution standards, in 1-2% nitric acid. Net counts were calibrated using a “two-point” calibration system involving a blank and a high standard that was prepared to be slightly more concentrated than the highest concentration sample, thus bracketing the concentration range of the samples. Three to four additional standards, spanning the full concentration range of the samples, were also prepared and run as “unknowns” to confirm linear calibration curves and to monitor reproducibility. Samples were run in duplicate and averaged.

The amount of metal adsorbed per unit mass of electrochemically modified (ECM)-chitosan, qₑ, was calculated using formula:

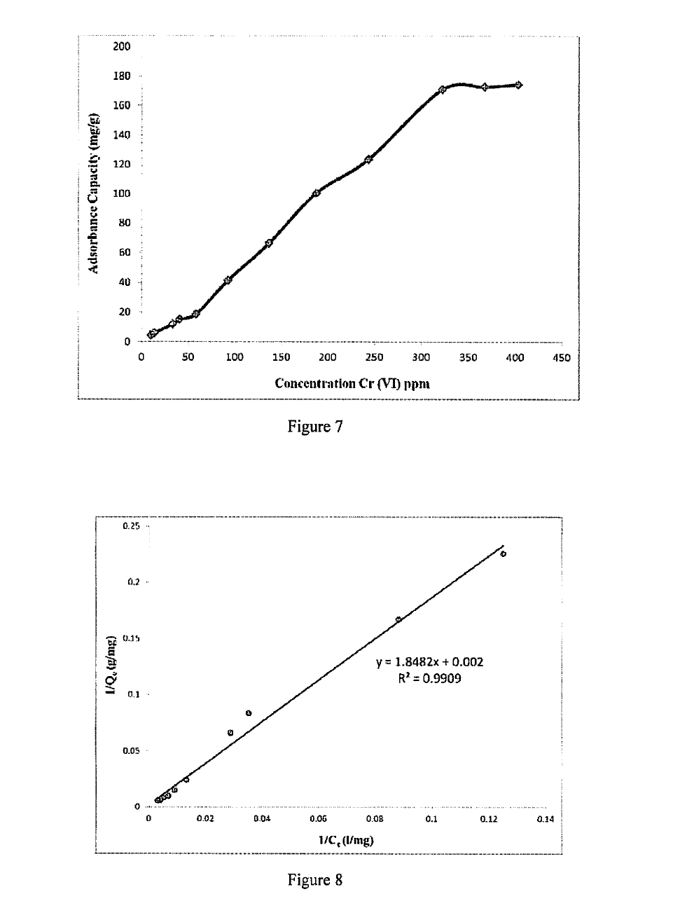

qₑ=(Cᵢ−Cₑ)V/M equation (4)

where Cᵢ is the initial concentration and Cₑ is equilibrium concentration in mg/l and M is dry mass of adsorbent in mg. The results of batch equilibrium adsorption are shown in FIG. 7. The amount of chromium adsorbed by unit mass of ECM-chitosan of the present disclosure increased with initial concentration of chromium till a plateau was achieved at 300 ppm. The adsorption capacity was found to be 174.4 mg Cr(VI)/g of ECM-chitosan.

Equilibrium adsorption isotherms were used to investigate interactive behavior between the solution and adsorbent. A widely used Langmuir model, which was representative of monolayer adsorption occurring on an energetically uniform surface without interactive molecules, was found to fit the process successfully (FIG. 8). The Langmuir model (equation 5) and its linear transformation (equation 6) are given below.

qₑ=qₘBCₑ/(1+BCₑ) equation (5)

1/qₑ=1/qₘ+1/bqₘCₑ equation (6)

where qₑ is equilibrium adsorption capacity (mg/g), Ce is the solution concentration at equilibrium (mg/l), qₘ is the Langmuir constant representing maximum adsorption capacity (mg/g), and b is the Langmuir constant related to energy of adsorption (l/mg). The calculated value of qₘ was 500 mg/g, which was well above the experimentally observed value. The calculated value of b was 0.001 l/mg, with a correlation coefficient (R²) of 0.9909. A dimensionless separation factor (R_{L}) was used to determine efficiency of adsorption obtained by equation R_{L}=1/(1+bC₀) where C₀ was initial concentration. The positive value calculated for b ensured an R_{L} value between 0 and 1 indicating the process of adsorption was feasible.

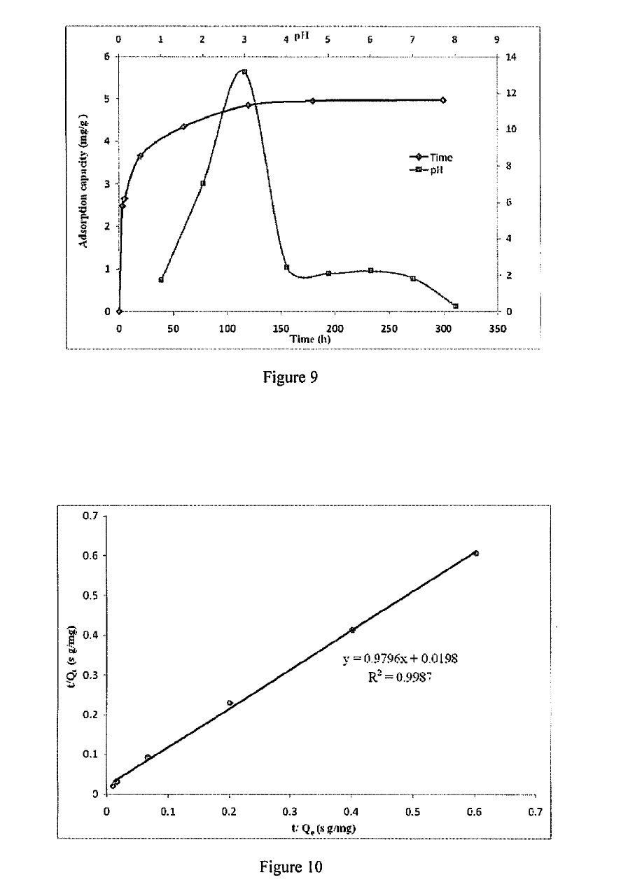

The pH of the adsorption medium influenced the physicochemical interactions between dissolved ions and adsorptive sites on the adsorbent. The effect of pH on adsorption of chromium (VI) by electrochemically modified chitosan in the pH range of 1 to 8 is shown in FIG. 9. The maximum adsorption of Cr was observed at pH 3 followed by a plateau region between pH 4-7, while the adsorption capacity of ECM-Chitosan was found to collapse on reaching pH 8. Chromium exists as H₂CrO₄ at pH less than 2, which accounts for the low value of adsorption at very low pH. The precipitation of chromium due to presence of OH⁻ ions was a contributing factor towards the near complete lack of adsorption at pH higher than 8.

Chromium removal by ECM-chitosan as a function of contact time is shown in FIG. 10. The reaction was initially rapid, with 50% metal uptake complete within the first 5 minutes, after which it proceeded slowly and equilibrium was achieved in 3 hours. To further investigate adsorption, mechanism and rate controlling step kinetic models were used. Pseudo first order, pseudo second order, as well as inter particle diffusion models were used for analysis. The pseudo second order reaction (equation 7) was found to fit the experimental data successfully (FIG. 10).

t/qₜ=1/kqₑ²+t/qₑ equation (7)

The value of k was found to be 2.038 g/mgh, with a linear correlation coefficient of 0.9987, indicating that the rate controlling step in chromium adsorption was chemisorption involving valence forces through the sharing or exchange of electrons between chromium and ECM-chitosan in the concentration range tested.

The above Examples demonstrate that an electrochemically precipitated and photochemically modified form of chitosan was prepared, possessing significant value in removal of toxic chromate oxyanions from solution. Fourier Transform Infra Red (FTIR), Raman and X-Ray photoelectron spectroscopy (XPS) indicated that a significant percentage of the amine functional groups were oxidized to nitro groups as a result of reactions with hydroxyl ions formed in the electrochemical process, with additional oxidation occurring as a result of exposure to ultraviolet light.

The adsorption capacity of the modified chitosan for chromate was investigated in a batch system by taking into account effects of initial concentration, pH of the solution and contact time. Nitro-chitosan showed greater adsorption capacity towards Cr (VI) than other forms of chitosan, with a maximum adsorption of 173 mg/g. It was found that the optimum pH for adsorption was 3, a Langmuir model was the best fit for the adsorption isotherm, and the kinetics of reaction followed a pseudo second order function.

While the above description contains many specific details of methods in accordance with this disclosure, these specific details should not be construed as limitations on the scope of the disclosure, but merely as exemplifications of preferred embodiments thereof. Those skilled in the art will envision many other possible variations that are all within the scope and spirit of the disclosure.

What is claimed is:

1. A process comprising:
contacting chitosan with a solvent to form a chitosan solution;
adding to the chitosan solution an acid selected from the group consisting of hydrochloric acid, hypochlorous acid, organic acids, and combinations thereof, to reduce the pH of the chitosan solution to a pH from about 1 to about 7;
applying a negative potential of from about −1 volt to about −5 volts to the chitosan solution by the introduction of a cathode and anode into the chitosan solution;
forming a hydrogel comprising a nitro-chitosan derivative on the cathode; and
recovering the nitro-chitosan derivative from the cathode.

2. The process of claim 1, wherein the solvent is selected from the group consisting of water, alcohols, or other polar solvents and combinations thereof, and wherein the chitosan is present in an amount from about 1% by weight to about 50% by weight of the chitosan solution.

3. The process of claim 1, wherein the chitosan solution is formed with heating from about 10° C. to about 90° C.

4. The process of claim 1, wherein the chitosan solution is formed with mixing at a rate of from about 1 revolution per minute to about 1000 revolutions per minute.

5. The process of claim 1, wherein the chitosan solution is formed over a period of time from about 1 minute to about 48 hours.

6. The process of claim 1, further comprising exposing the hydrogel on the cathode to a source of radiation selected from the group consisting of ultraviolet, X-Ray, gamma radiation, and combinations thereof.

7. The process of claim 6, wherein the source of radiation comprises ultraviolet radiation at a wavelength from about 50 nm to about 400 nm.

8. The process of claim 1, wherein the nitro-chitosan derivative includes a monomer of the following formula:

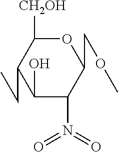

9. The process of claim 1, wherein the nitro-chitosan derivative includes a monomer of the following formula:

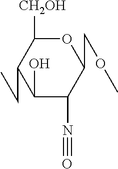

10. The process of claim 1, further comprising contacting groundwater with the nitro-chitosan derivative to remove chromium from the groundwater.

11. The process of claim 1, further comprising contacting soil with the nitro-chitosan derivative to remove chromium from the soil.

12. A process comprising:
contacting chitosan with a solvent to form a chitosan solution;
adding to the chitosan solution an acid selected from the group consisting of hydrochloric acid hypochlorous acid, acetic acid, and combinations thereof, to reduce the pH of the chitosan solution to a pH from about 1 to about 7;
applying a negative potential of from about −1.25 volts to about −3 volts to the chitosan solution by the introduction of a cathode and anode into the chitosan solution;
forming a hydrogel comprising a nitro-chitosan derivative on the cathode;
exposing the hydrogel on the cathode to a source of radiation selected from the group consisting of ultraviolet, X-Ray, gamma radiation, and combinations thereof; and
recovering the nitro-chitosan derivative from the cathode.

13. The process of claim 12, wherein the solvent is selected from the group consisting of water, alcohols, and combinations thereof, and wherein the chitosan is present in an amount from about 1% by weight to about 50% by weight of the chitosan solution.

14. The process of claim 12, wherein the chitosan solution is formed with heating from about 10° C. to about 90° C.

15. The process of claim 12, wherein the chitosan solution is formed with mixing at a rate of from about 1 revolution per minute to about 1000 revolutions per minute.

16. The process of claim 12, wherein the chitosan solution is formed over a period of time from about 1 minute to about 48 hours.

17. The process of claim 12, wherein the source of radiation comprises ultraviolet radiation at a wavelength from about 50 nm to about 400 nm.

18. The process of claim 12, wherein the nitro-chitosan derivative includes a monomer of the following formula:

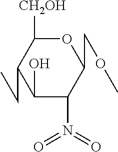

19. The process of claim 12, wherein the nitro-chitosan derivative includes a monomer of the following formula:

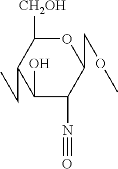

20. The process of claim 12, further comprising contacting groundwater with the nitro-chitosan derivative to remove chromium from the groundwater.

21. The process of claim 12, further comprising contacting soil with the nitro-chitosan derivative to remove chromium from the soil.
